(19) United States
(12) Patent Application Publication
(10) Pub. No.: US 2008/0024519 A1
(43) Pub. Date: Jan. 31, 2008

(54) System and method for producing paintings

(76) Inventor: Alberto Blanco, Roseland, NJ (US)

Correspondence Address: ROGER M. RATHBUN, 13 MARGARITA COURT, HILTON HEAD ISLAND, SC, 29926, US

(21) Appl. No.: 11/492,422

(22) Filed: Jul. 25, 2006

(51) Int. Cl. G09G 5/00

(52) U.S. Cl. 345/619

(57) ABSTRACT

A method and apparatus for producing simulated paintings by means of a commercial software programs that enhances a digital representation of a scene or portrait. The enhancement can include various composing steps on the digital representation as well as the adding of electronic brush strokes to the digital representation by a commercial software program. The enhanced digital representation is then transmitted from a first location to a second, remote location by the internet or other transmission system. At the second location, the digitally enhanced representation is printed onto a substrate, such as an artists canvas, and actual paint is applied to that canvas by a skilled person to create the simulated oil painting.

### BACKGROUND

The present invention relates to system and method of producing a painting and, more particularly, to a system and method that produces a painting having electronically generated brush strokes on a substrate and transmitting the painting to a remote location where the work can be hand painted.

There are certainly various techniques to produce a portrait or landscape size picture by the use of commercially available painting software packages to produce, from a snapshot or other picture of the desired subject, a picture of the desired size that can be produced by a commercially available printer onto a canvas that has brush strokes created by means of the software package. A typical software package that can be used to produce electronically simulated brush strokes in a digitally stored picture is Painter 7™ by the Procreate Division of Corel, Inc.

With such software, the digitized pictures are simply enhanced by adding brush strokes electronically by a palette and an electronic stylus or directly on a computer screen or tablet and the picture so produced can be printed out by means of an ink jet printer to produce a picture that shows brush strokes added by the software program to make the picture look more like an original oil painting.

While the brush strokes do enhance the look of the picture, the pictures so created are still two dimensional so that an additional step or steps are required to create a three dimensional effect that is more desirable and more akin to the look of an authentic oil painting.

As such, therefore, while the aforedescribed technique produces a good simulated oil painting, it would be advantageous to have a system that would allow the electronic transmission of that brush stroked enhanced image to a remote location where an individual could personally add a final hand painted image.

### SUMMARY OF THE INVENTION

Accordingly, the present invention relates to a method and system for producing a simulated oil painting type of picture that can be produced with the aid of computer programs and thereafter transmitted electronically to a remote location where a skilled person can hand paint onto the electronically transferred painting that has been electronically enhanced.

With the present invention, therefore, initially a work, such as a photograph is digitized so as to be available in the form of a digital file and such action may be by a scanner, digital camera or the like. The digital file or work can then be modified with a commercially available software program in a computer to carry out various routines on the work, for example using a commercial program such as PhotoShop 7™ available from Adobe Software, the digital work can be cropped, color corrected and the color generally enhanced in a computer. As a step of the process, the color in the digitized work can be saturated to exaggerate the colors such that the work actually becomes more artistic.

To that enhanced image, the digital electronic file of the enhanced work or painting can then be further processed by the use of another commercially available computer software program known as Painter 7™ by the Procreate Division of Corel, Inc and which adds brush strokes to the digitized work. With the Painter 7 software program, a set of electronic brushes is used to add brush strokes to the work to produce a color image that has brush strokes added to the image.

Thereafter, the digital representation of the photograph that now has the brush strokes added thereto is transmitted to a remote location by electronic means such as via the internet. The transmitted version can be printed out at the remote location and is a reproduction of the original photograph with the addition of the electronically added brush strokes.

Accordingly, at the remote location, a skilled individual can hand paint over the printed electronically painted representation with the use of a traditional oil paint, or, more significantly, with a special thermal-drying paint such as the Genesis brand of artists colors, manufactured by American Art Clay Co., Inc. of Indianapolis, Ind. While traditional oils take six to eight weeks to dry, a thermal-drying paint will dry instantly.

Accordingly, a user at a location remote from the original electronic version with the added brush strokes can customize the picture by adding the further hand painted coating onto the electronically transmitted version of the picture to result in an authentic looking oil painting.

These and other features and advantages of the present invention will become more readily apparent during the following detailed description taken in conjunction with the drawings herein.

### BRIEF DESCRIPTION OF THE DRAWINGS

FIG. 1 is flow chart outlining the steps in carrying out the preferred embodiment of the present invention; and

FIG. 2 is a schematic view showing the actual steps carried out in the exemplary embodiment.

### DETAILED DESCRIPTION OF THE INVENTION

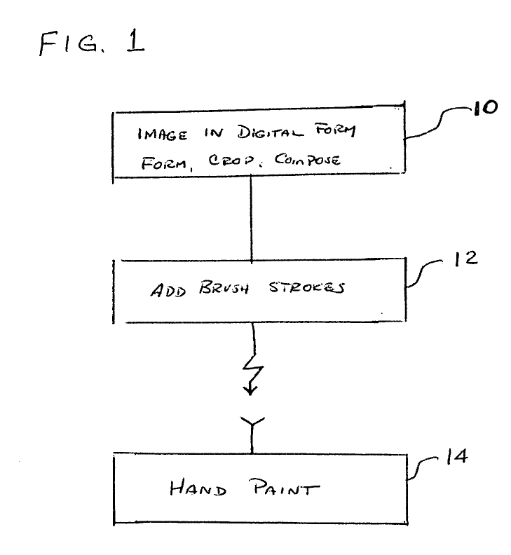

Referring now to FIG. 1, there is shown a flow chart illustrating the various steps in carrying out the exemplary embodiment of the present invention. As can be seen, the initial step, indicate by the block 10 is to carry out various, somewhat conventional, alterations to a work, such as a photograph, to prepare it for the later steps in creating the desired oil painting look. Thus, the step of block 10 can include the use of commercially available software, such as PhotoShop™ 7, marketed by Adobe Software.

Accordingly, as the first steps, the particular work, typically a photograph, is digitized to enable the software program to make the desire alterations and, of course, to carry out the later steps of the invention. That digitizing can be by means of a scanner, if the work is embodied in a normal color photograph or may be initially digitized, for instance, if the particular work has been memorialized by use of a digital camera or in some other way is available in some electronic medium.

In any event, the digital representation is then processed by the commercial software program to carry out various enhancing and editing steps to process the work into the form desired by the user. For example, the work may be subjected to a color correction to enhance and saturate the colors, particularly skin colors and skin tones, such that the overall work takes on a more artistic form. Additional enhancing features or steps can include cropping of the work, adding borders, composing the work, merging different works into one work or, the opposite, separating out a particular subject from a series of subjects in a work. For example, if the work is a photograph, a particular portion of the photograph may be selected and that portion can be electronically isolated and composed for the processing in accordance with the present invention.

The ultimate product of the processing steps undertaken in block 10 of the flow chart, therefore, is a two dimensional creation of a work that has been processed to select and enhance the particular subject matter that is desired to be subjected to the oil painting simulation process. Accordingly, that final product is saved and stored digitally by the computer as a file that is identified for the further processing steps.

Turning now to block 12 of the flow chart of FIG. 1, further processing steps are carried out on the digitally stored file obtained as a result of the composing and enhancing steps carried out in block 10. In block 12, the digital work from block 10 is processed by means of a further commercial software program that adds brush strokes to the work, and one such program to create the brush stroke effect or pattern is available as Painter 7™ marketed by the Procreate Division of Corel Co.

With such software program there are various ways to add the brush strokes to the digital work, and such means includes the use of a tablet and the brush stroke pattern can be added, for example, by the manipulation of a mouse or a pressure sensitive stylus. Basically the software creates or provides a set of electronic brushes that take the color information from the original digitized work and apply a brush stroke pattern to the work. The brush stroke technique can be in accord with the user's artistry and the strokes can be electronically varied between broad and narrow brush strokes as well as heavy and light strokes; however in any event, the technique via commercial software adds brush strokes to the various colors of the original work.

At this point, the painted digital electronic representation of the original photograph is transmitted electronically to a remote location. The transmitted representation or work is basically the original digitized work that now has had brush strokes applied in the step of block 12 but is still a two dimensional work.

Thus, in block 14 the step in the present invention takes place at some remote location by an individual who has received and printed out the painted digital electronic representation of the photograph. The transmission of the work from that created at block 12 to block 14 can be via the internet or other transmission medium such that the representation is forwarded to a remote location where a skilled person is located that carries out the further step of applying actual paint to the work.

As such, the individual at a remote location from where the procedures shown in block 12 and 14 take place, hand paints over that representation to create a further painted coating thereon. Thus, the individual is capable of customizing the work by the hand painting step and may use an oil paint or some special quick drying paint. In one embodiment, the hand painted coating can be relatively transparent such that the electronically brush stroked picture can still appear through the final hand coated paint.

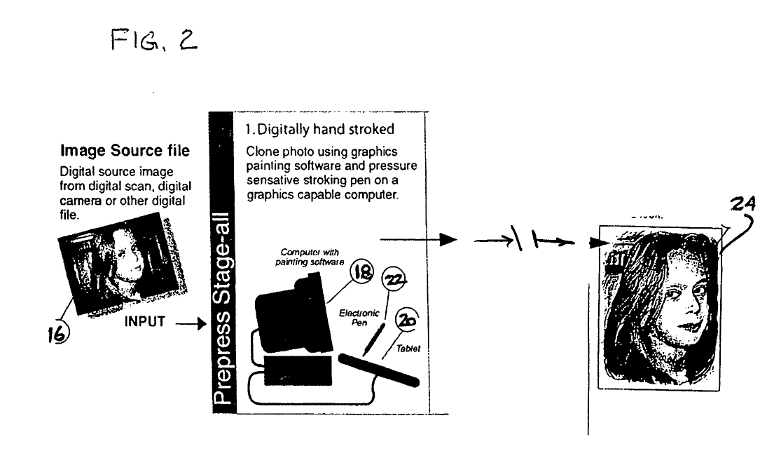

Turning now to FIG. 2, taken along with FIG. 1, there is shown a schematic view of the method of the present invention. In FIG. 2, the image 16 is a photograph that is selected, for example, by an individual for processing by means of the present invention. That photograph image 16 is thereafter digitized by means of a digital camera, scanner of the like in order to obtain a digital representation of the image 16.

That digital image is then imputed to a graphics capable computer 18 where the digital image is cloned by the use of graphics painting software, such as Painter 7™, where a tablet 20 is used in conjunction with an electronic pen 22. Basically, the digital image is projected upon the tablet 20 and the electronic pen 22 used to add the brush stroke pattern electronically on to the digital image. The electronic pen 22 can be adjusted in accordance with the commercially available software to change the width of the brush strokes and the electronic pen 22 can lay heavy or light strokes in accordance with the touch of the user. Thus, a textured, albeit still two dimensional, digital image is created that is a painted digital electronic representation of the original photograph with the addition of brush strokes.

That representation is electronically transmitted, such as via the internet, to a remote location where a print 24 is made at that location of the digital representation having brush strokes. Preferably, the print 24 is produced by a commercial ink jet printer and is printed on an artist canvas, however other printers and mediums or substrates can be used to make the print 24.

Accordingly, at the remote location, the print 24 is hand painted by an individual, as previously described to create a painting of the original photograph that has been hand crafted or painted by an individual. Again as described, the hand painting step utilizes a traditional oil paint, or, more preferably, a special thermal-drying paint such as the Genesis brand of artists colors, manufactured by American Art Clay Co., Inc. of Indianapolis, Ind. The thermal-drying paint, of course speeds up the overall process by drying at a considerable faster time than the traditional oil paints.

Thus, there is created, by the aforedescribed steps, a representation of the original photograph or other work that has been processed to result in a painting that is ultimately finished by the application of actual oil painting strokes at a location remote from where the enhancing and adding of brush strokes took place and the final work resembles an authentic original painted work.

Those skilled in the art will readily recognize numerous adaptations and modifications which can be made to the simulated painting process and apparatus of the present invention which will result in an improved painting, yet all of which will fall within the scope and spirit of the present invention as defined in the following claims. Accordingly, the invention is to be limited only by the following claims and their equivalents.

What is claimed is:

1. A method for producing a painting comprising the steps of:
producing a digital representation of a scene or portrait;
electronically enhancing the digital representation at a first location by an electronic painting program to produce an enhanced digital electronic representation of the scene or portrait,
electronically transferring the enhanced digital electronic representation of the scene or portrait to a remote location, and
adding paint to the enhanced digital electronic representation to create a painting.

2. The method of claim 1 wherein the step of producing a digital representation comprises scanning a photograph of the scene or portrait.

3. The method of claim 1 further including the step of electronically transferring enhanced digital electronic representation of the scene or portrait to a canvas.

4. The method of claim 3 wherein the step of adding paint comprising hand painting on the canvas over the enhanced digital electronic representation.

5. The method of claim 4 wherein the step of hand painting comprises hand painting using a traditional oil paint.

6. The method of claim 4 wherein the step of hand painting comprises hand painting using a special non-drying paint.

7. The method of claim 1 wherein the step of electronically enhancing the digital representation includes the step of re-touching the representation to prepare the representation for painting.

8. The method of claim 1 wherein the step of electronically enhancing the digital representation includes adding brush strokes to the digital representation by means of a commercial software program.

9. The method of claim 8 wherein the brush strokes are added by the use of an electronic paint brush.

10. The method of claim 8 wherein the brush strokes are added by the use of an electronic tablet with an electronic pen.

11. The method of claim 8 wherein the step of adding brush strokes includes the step of controlling the breadth of the brush strokes.

12. A method for producing a painting comprising the steps of:
producing a digital representation of a scene or portrait;
electronically enhancing the digital representation at a first location by an electronic painting program to produce an enhanced digital electronic representation of the scene or portrait,
electronically transferring the enhanced digital electronic representation of the scene or portrait to a second location,
printing the enhanced digital electronic representation onto a substrate at the second location, and
hand painting the substrate over the enhanced digital electronic representation.

13. The method of claim 12 wherein the step of electronically transferring the enhanced digital electronic representation comprises transmitting the representation over the world wide web.

14. The method of claim 12 wherein the step of printing the enhanced digital electronic representation comprises printing the representation onto an artist canvas.

15. The method of claim 12 wherein the step of electronically enhancing the digital representation includes electronically adding brush strokes by means of a commercial software program.

16. The method of claim 12 wherein the step of hand painting on the canvas comprises hand painting utilizing a fast drying paint.

17. The method of claim 12 wherein the step of electronically enhancing the digital representation comprises at least one of the steps comprised of cropping, composing and forming.

18. A system for producing a simulated painting from a scene of portrait comprising:
a digitizer to convert the scene or portrait to a digital representation;
a software program operable by a computer to electronically enhance the digital representation;
a transmitting system to enter the electronically enhanced representation through the internet at a first location to be received at a second location; and
a printer to print the electronically enhanced representation out onto a substrate at the second location.

19. The system of claim 18 wherein the software program is adapted to enhance the digital representation by adding brush strokes to the digital representation.

20. The system of claim 18 wherein the digitizer is adapted to scan and digitize a photograph of the scene or portrait.
